(19) United States
(12) Patent Application Publication
(10) Pub. No.: US 2010/0247727 A1
(43) Pub. Date: Sep. 30, 2010

(54) System and Method for Cooking a Food Product

(76) Inventor: Edwin G. Atwell, Almonte (CA)

Correspondence Address: FISH & RICHARDSON P.C., P.O. BOX 1022, MINNEAPOLIS, MN, 55440-1022, US

(21) Appl. No.: 12/797,071

(22) Filed: Jun. 9, 2010

Related U.S. Application Data
(63) Continuation-in-part of application No. 12/380,036, filed on Feb. 23, 2009.

(30) Foreign Application Priority Data
Dec. 30, 2009 (CA) 2,689,352

(51) Int. Cl. A23L 1/01; A47J 37/00; A47J 37/12

(52) U.S. Cl. 426/438; 99/339; 99/404; 99/409; 99/407

(57) ABSTRACT

A system and method for producing a cooked food product using multiple sections is described. The system includes a frying section for receiving and frying an uncooked food product to produce a partially cooked food product; a transition section operatively connected to the frying section for receiving and conveying the partially cooked food product at a substantially stable food temperature; and a baking section operatively connected to the transition section for receiving and baking the partially cooked food product conveyed from the transition section to produce the cooked food product.

### CLAIM OF PRIORITY

Under 35 U.S.C. §119, this application claims the benefit of a foreign priority application filed in the Canadian Patent Office, serial number 2,689,352, filed Dec. 30, 2009, the entire contents of which is hereby incorporated by reference.

This application is a continuation-in-part and claims priority to U.S. patent application Ser. No. 12/380,036, filed Feb. 23, 2009, currently pending, the entire contents of which is incorporated by reference.

### TECHNICAL FIELD

The present invention relates to the field of food product cooking systems and methods.

### BACKGROUND

Cooking is most generally defined as a process of preparing food by applying heat. During the cooking process, the flavor, texture, appearance and chemical properties of the ingredients can change. Cooking can involve baking, frying, grilling, boiling, steaming and microwaving, to name but a few examples. Various methods use differing levels of heat and moisture and by varying cooking time of a particular food product and the method used can greatly affect the end result of the cooked food.

Generally, current systems and methods for cooking are focused on one of the many cooking options independently. For example, one either fries donuts or bakes them (as in yeast donuts). There is a need for a system of cooking food products that combines the features of independent cooking systems to produce food products with different end results as discussed above.

### SUMMARY

Certain exemplary embodiments provide a system for producing a cooked food product, the system comprising: i) a frying section for receiving and frying an uncooked food product to produce a partially cooked food product; ii) a transition section operatively connected to the frying section for receiving and conveying the partially cooked food product at a substantially stable food temperature; and iii) a baking section operatively connected to the transition section for receiving and baking the partially cooked food product conveyed from the transition section to produce the cooked food product.

Certain exemplary embodiments can provide a system for producing a cooked food product, the system comprising: i) means for frying an uncooked food product in a frying medium to produce a partially cooked food product; ii) means for baking the partially cooked food product to produce the cooked food product; and iii) means for transitioning the partially cooked food product from the means for frying to the means for baking at a substantially stable food temperature.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic illustration of a food cooking system and method according to an embodiment of the present invention;

FIG. 2 is a detailed side schematic illustration of the food cooking system shown in FIG. 1;

FIG. 3 is a top view of a portion of the conveyance mechanism shown in FIG. 2;

FIG. 4 is a perspective view of the system of FIG. 1 shown from the frying section;

FIG. 5 is a perspective view of the system of FIG. 1 shown from the baking section; and

FIG. 6 is a detailed side view of a section of the system of FIG. 1 shown with the cover of the transition section removed.

Like reference symbols in the various drawings indicate like elements.

### DETAILED DESCRIPTION

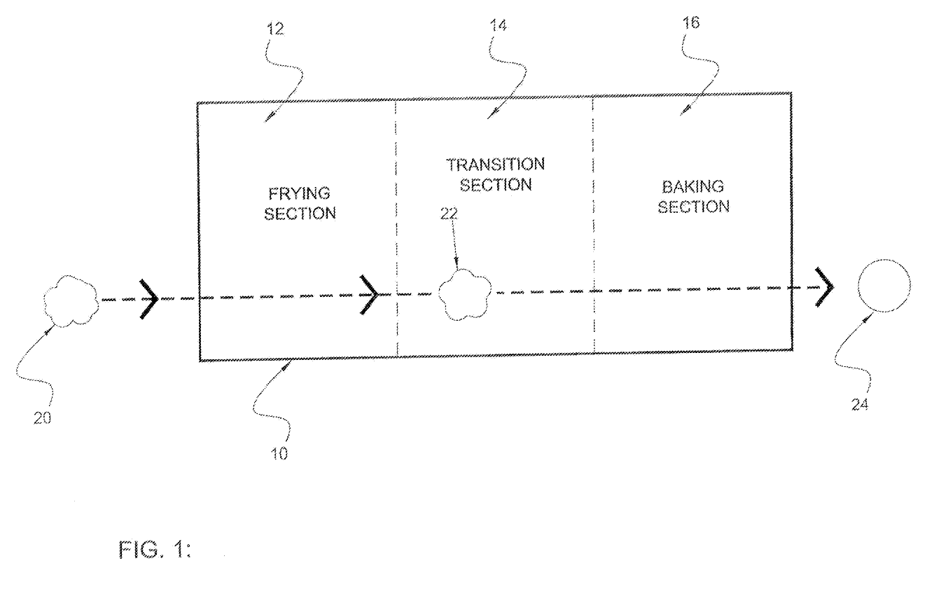

FIG. 1 schematically illustrates a system 10 for cooking a food product (such as donuts, fish sticks, French fries, onion rings, calamari rings, chicken pieces, etc.). The system 10 includes a frying section 12 operable with a transition section 14 and a baking section 16 operable with the transition section 14. An uncooked food product 20 is introduced into the frying section 12 to initiate the cooking process and produce a partially cooked food product 22.

The partially cooked food product 22 produced in the frying section 12 is received by and conveyed through the transition section 14 at a stable food temperature to the baking section 16 to complete the cooking process and produce a cooked food product 24. In particular, during movement from the frying section 12 to the baking section 16 the transition section 14 assists in limiting/reducing the cooling of the partially cooked food product 22 by maintaining a temperature in the transition section 14 to substantially maintain the temperature of the partially cooked food product 22 prior to completing the cooking process in the baking section 16.

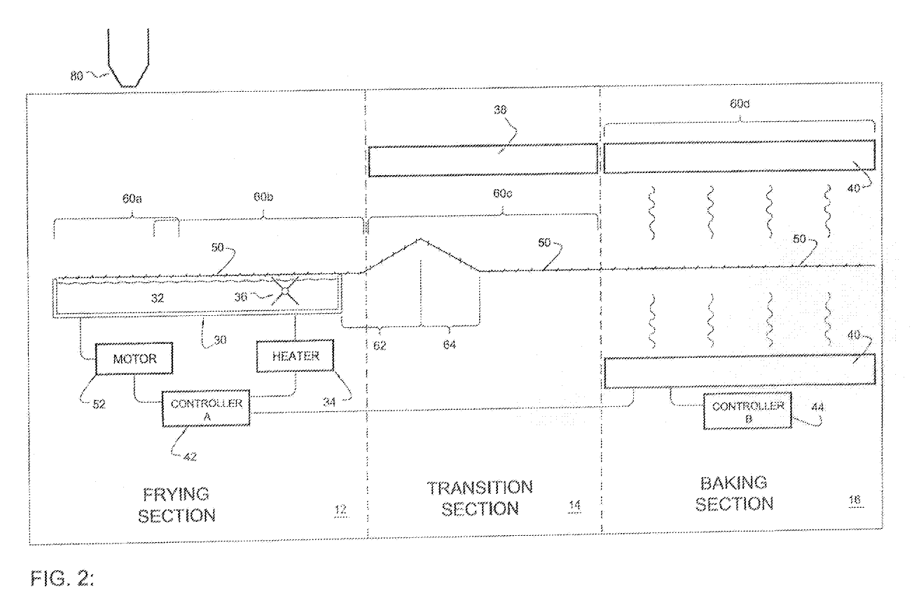

Referring to the schematic cross section of the apparatus 10 in FIG. 2, the frying section 12 includes a tank/reservoir 30 for retaining a supply of a frying medium 32 (such as cooking oils, lard, shortening, etc.) and a heater 34 for heating the frying medium 32 to a temperature suitable for frying the uncooked food product. The temperature of the frying medium 32 is controlled by a controller A 42, which is connected to the heater 34.

The temperature of the frying medium 32 varies depending on the type of food being cooked but typically ranges from 250° F. to 500° F. (120° C. to 260° C.). For example, for frying donuts the frying medium temperature can be between 325° F. to 375° F. (160° C. to 190° C.), for meat products the frying medium temperature can be between 350° F. to 450° F. (175° C. to 230° C.). The uncooked food product 20 is initially deposited in the tank 30 for frying (i.e., the food is substantially surrounded by the frying medium to ensure an even frying process). The frying section 12 may also include a flipping mechanism 36 for flipping the food product during the frying process to assist in evenly cooking both sides of the food product.

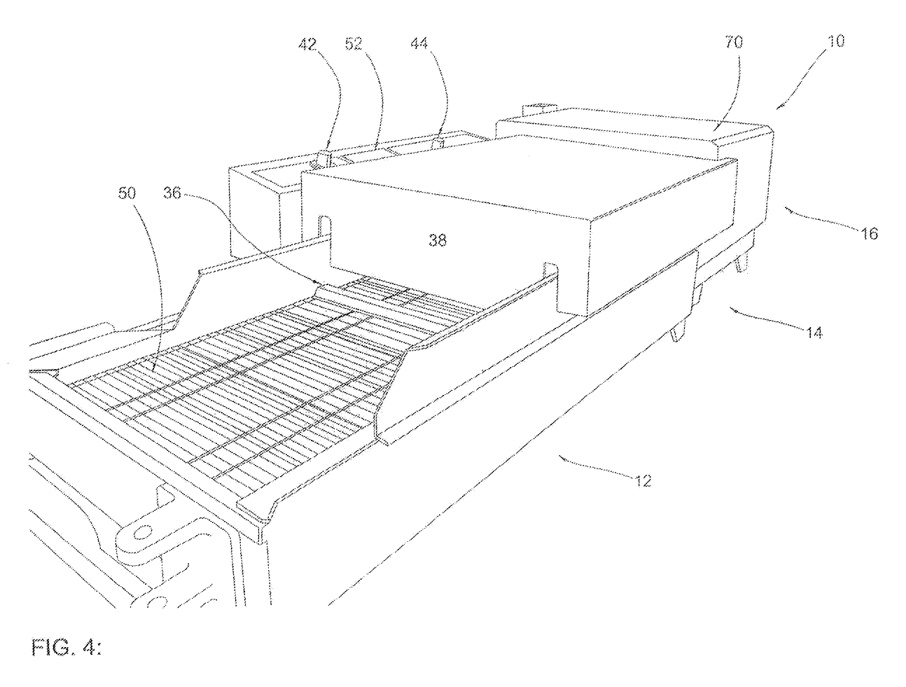

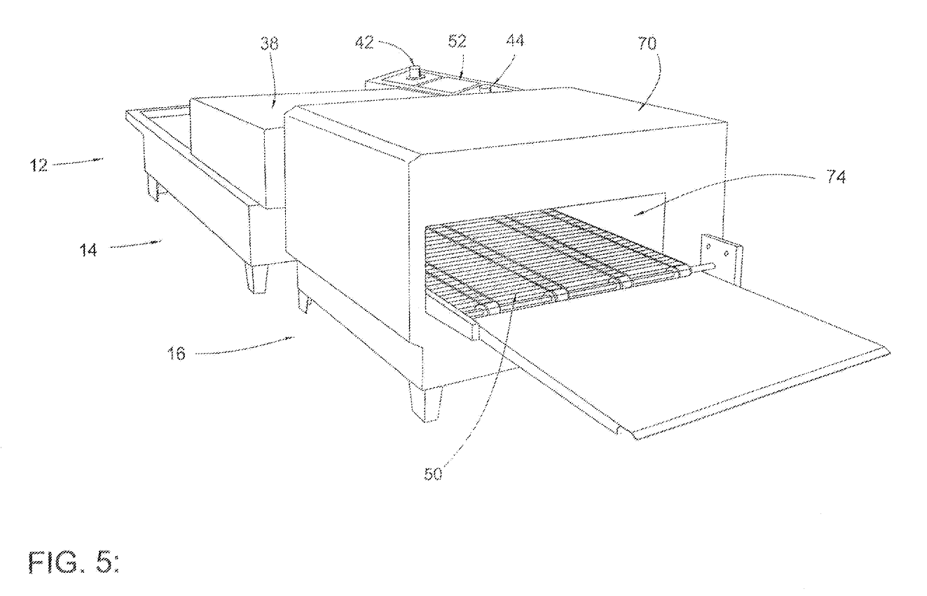

The transition section 14 includes a heat retention mechanism for maintaining the partially cooked food product 22 at a stable food temperature (i.e., to minimize food temperature loss during transfer from the frying section 12 to the baking section 16). In the embodiment shown in FIGS. 4 and 5, an insulated cover 38 (made from double wall insulated stainless steel, for example) acts as the heat retention mechanism for maintaining the partially cooked food product 22 at a stable food temperature. This arrangement permits heat from the baking section 16 to extend into and be maintained by the transition section 14.

As a result, in certain implementations, the temperature in the transition section 14 is similar to the temperature in the baking section 16, and remains generally stable. In the embodiment shown in FIGS. 4 and 5, the partially cooked food product 22 can effectively start the baking process in the transition section 14 based on this heat transfer from the baking section 16. Other heat retention mechanisms can be used in the transition section 14, such as fans that can be arranged to blow warm air in the transition section 14.

The baking section 16 includes an oven enclosure 70 (see FIGS. 4-6) having an entry opening 72 and an exit opening 74 and one or more heat sources 40 (see FIG. 2) for generating a baking temperature suitable for completing the cooking of the partially cooked food product 22 to generate the cooked food product 24. The baking temperature varies depending on the type of food being cooked but typically ranges from 300° F. to 400° F. (145° C. to 205° C.). The temperature of the heating sources 40 can be controlled by the controller A 42 or with a separate controller B 44.

The system 10 includes a conveyance mechanism for moving the food product through the various sections 12, 14, and 16. The conveyance mechanism can included either singly or in combination: a continuous conveyor belt type system 50 (as shown), blowers, oil stream, and moving trays. The conveyance mechanism 50 can be one continuous system that extends through all sections 12, 14, and 16 or can he separate, independent and operably connected sub-systems such that the food product (at the various stages of preparation 20, 22, 24) moves through the sections 12, 14, and 16 in a manner to permit proper cooking of the food product.

A motor 52 drives the movement/speed of the conveyance mechanism 50. The motor 52 is controlled by the controller A 42, which can also be used to control the temperature of the frying medium 32 (as discussed above).

The speed at which the food moves through the various sections 12, 14, and 16 depends on the type of food being prepared. See Table 1 for specific examples and for a comparison with traditional frying methods. For many food products, such as donuts, chicken pieces, and frozen fish the overall cooking time through the system 10 is similar to the cooking time using frying alone, yet with healthier benefits as less fat is absorbed by the food product using the system 10.

TABLE 1

| | COOKED IN A | |
|---|---|---|
| | TRADITIONAL | |
| FOOD PRODUCT | OIL FRYER | COOKED USING SYSTEM 10 |
| Chicken pieces (such as | 10 minutes in 400° F. | 4 minutes in 400° F. frying medium (in |
| chicken wings, and | oil | the frying section 12) and 6 minutes (in |
| chicken nuggets) | | the baking section 16 at 400° F. |
| | | including movement through the |
| | | transition section 14) |
| Donut | 120 seconds in 375° F. | 50 seconds in 375° F. frying medium (in |
| | oil | the frying section 12) and 70 seconds |
| | | (in the baking section 16 at 375° F. |
| | | including movement through the |
| | | transition section 14) |
| Fish (such as frozen fish | 5 minutes in 370° F. | 2 minutes in 370° F. frying medium (in |
| sticks) | oil | the frying section 12) and 3 minutes (in |
| | | the baking section 16 at 370° F. |
| | | including movement through the |
| | | transition section 14) |

The conveyance mechanism 50 starts in the tank 30, from a food receiving region 60a, to a frying region 60b and then, after being partially cooked, to a transfer region 60c and finally to the baking region 60d. The regions 60a and 60b are shown as overlapping since the defined regions are approximate.

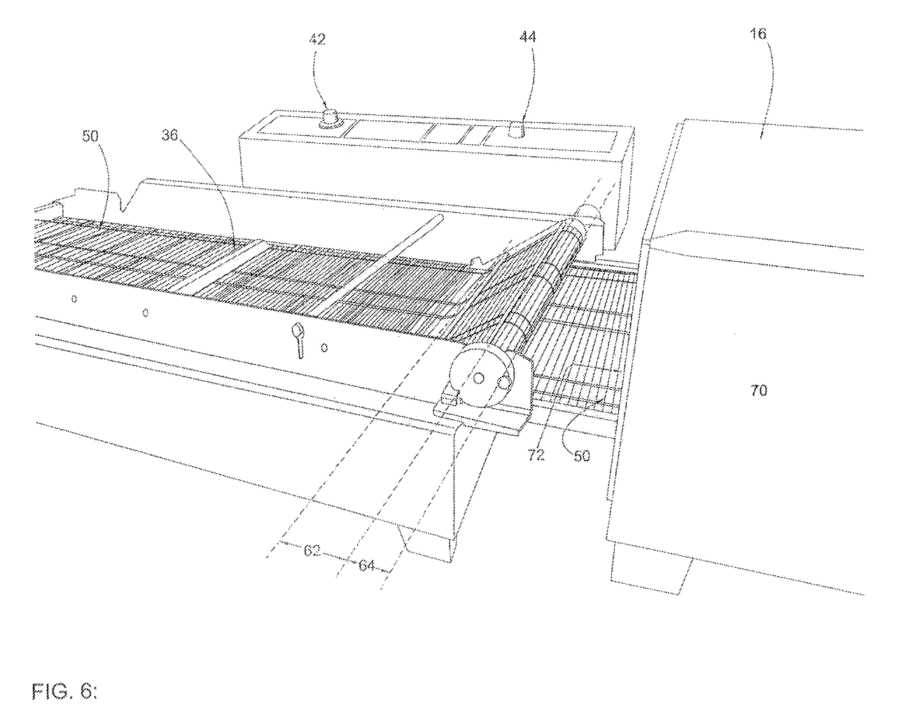

As shown in FIGS. 2 and 6, a section 62 of the conveyance mechanism 50 is upwardly angled for lifting the partially cooked food product 22 from the tank 30. After the partially cooked food product 22 is lifted out of the tank 30, a further section 64 transitions the conveyance mechanism 50 to the baking region 60d (i.e., into entry opening 72 of the oven enclosure 70) in the baking section 16.

Other types of mechanisms can be used to transfer the partially cooked food product 22 from the tank 30 to the baking section 16, including aligned conveyors, transfer hooks, transfer grips, or the like.

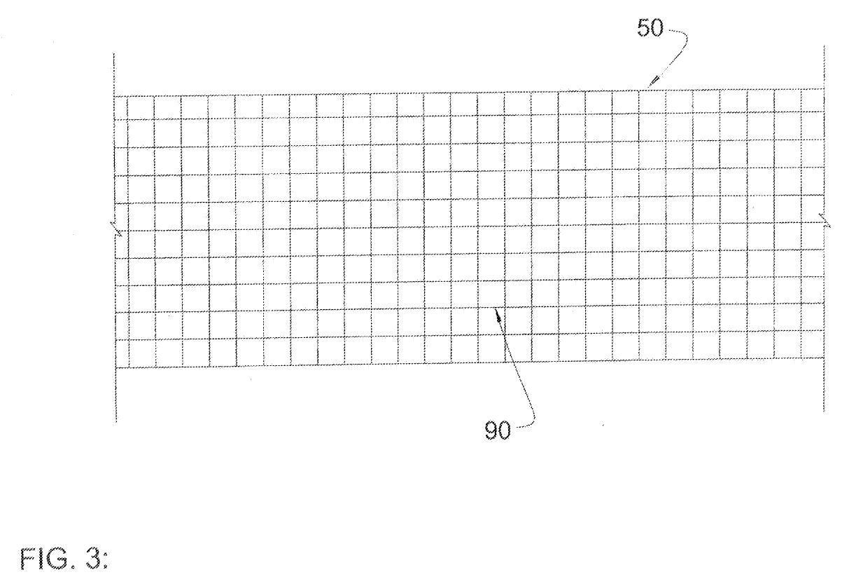

In a further embodiment, the conveyance mechanism 50 includes a perforated surface 90 as shown in FIG. 3 for enabling the draining of frying medium residue from the partially cooked food product 22 during conveyance from the frying section 12 to the baking section 16.

In a further embodiment, the system 10 includes a mechanism 80 (see FIG. 2) for dropping/placing/depositing the uncooked food product 20 in the tank 30 in the receiving region 60a of the frying section 12, such as a hopper and immersing trays.

A number of embodiments of the invention have been described. Nevertheless, it will be understood that various modifications may be made without departing from the spirit and scope of the invention.

What is claimed is:

1. A system for producing a cooked food product, the system comprising:
i) a frying section for receiving and frying an uncooked food product to produce a partially cooked food product;
ii) a transition section operatively connected to the frying section for receiving and conveying the partially cooked food product at a substantially stable food temperature; and
iii) a baking section operatively connected to the transition section for receiving and baking the partially cooked food product conveyed from the transition section to produce the cooked food product.

2. The system of claim 1, wherein the transition section includes a heat retention mechanism arranged between the frying section and the baking section for maintaining the substantially stable food temperature of the partially cooked food product during conveyance from the frying section to the baking section.

3. The system of claim 2, wherein the heat retention mechanism includes a heat insulated enclosure.

4. The system of claim 1, wherein the frying section includes an tank for retaining a supply of a frying medium, a heat source for heating the frying medium to a temperature, and a controller for controlling the temperature of the frying medium.

5. The system of claim 1, wherein the system further includes a conveyance mechanism for moving the food product from the frying section to the transition section and from the transition section to the baking section.

6. The system of claim 5, wherein the frying section includes a flipping mechanism for flipping the food product during movement in the tank by the conveyance mechanism.

7. The system of claim 5, wherein the conveyance mechanism limits delay of the conveyance of the partially cooked food product through the transition section.

8. The system of claim 5, wherein the conveyance mechanism is a continuous meshed conveyor belt system extending from the frying section, through the transition section and the baking section.

9. The system of claim 8, wherein the meshed conveyor belt system includes an upwardly angled section arranged at one end of the frying section for removing the partially cooked food product from the tank and a downwardly angled section for continuing through the baking section.

10. The system of claim 1, wherein the baking section includes an oven enclosure having an entry opening for receiving the partially cooked food product from the transition section and an exit opening for producing the cooked food product; the oven enclosure having a heat source for generating a baking temperature within the oven enclosure to produce the cooked food product from the partially cooked food product.

11. The system of claim 1, further comprising a mechanism for depositing the uncooked food product into a food receiving region of the tank.

12. A method for cooking a food product using the system of claim 1, comprising:
(a) providing an uncooked food product to the frying section;
(b) frying the uncooked food product in the frying section to produce a partially cooked food product;
(c) transitioning the partially cooked food product at a stable food temperature from the frying section to the baking section; and
(d) baking the partially cooked food product in the baking section to produce the cooked food product.

13. A system for producing a cooked food product, the system comprising:
i) means for frying an uncooked food product in a frying medium to produce a partially cooked food product;
ii) means for baking the partially cooked food product to produce the cooked food product; and
iii) means for transitioning the partially cooked food product from the means for frying to the means for baking at a substantially stable food temperature.

14. The system of claim 13, wherein the means for transitioning includes a heat retention means arranged between the means for frying and the means for baking for maintaining the substantially stable food temperature.

15. The system of claim 13, wherein the means for frying includes a receptacle means for retaining a supply of the frying medium, heat generating means for heating the frying medium to a temperature, and control means for controlling the temperature of the frying medium.

16. The system of claim 13, wherein the system further includes means for conveying the food product from the means for frying to the means for baking through the means for transitioning.

17. The system of claim 13, wherein the means for baking includes an enclosure having an entry for receiving the partially cooked food product from the means for transitioning and an exit to allow access to the cooked food product; the enclosure having heat generating means for generating a baking temperature within the enclosure to produce the cooked food product from the partially cooked food product.

18. A method for cooking a food product comprising:
(a) providing a system for producing a cooked food product, the system comprising:
i) a frying section for receiving and frying an uncooked food product to produce a partially cooked food product;
ii) a transition section operatively connected to the frying section for receiving and conveying the partially cooked food product at a substantially stable food temperature; and
iii) a baking section operatively connected to the transition section for receiving and baking the partially cooked food product conveyed from the transition section to produce the cooked food product;
(b) providing an uncooked food product to the frying section;
(c) frying the uncooked food product in the frying section to produce a partially cooked food product;
(d) transitioning the partially cooked food product at a stable food temperature from the frying section to the baking section; and
(e) baking the partially cooked food product in the baking section to produce the cooked food product.

19. The method of claim 18, wherein the step of providing a transition section includes providing a heat retention mechanism arranged between the frying section and the baking section for maintaining the substantially stable food temperature of the partially cooked food product during conveyance from the frying section to the baking section.

20. The method of claim 19, wherein providing a heat retention mechanism includes providing a heat insulated enclosure.
